(19) United States
(12) Patent Application Publication
(10) Pub. No.: US 2026/0195402 A1
(43) Pub. Date: Jul. 9, 2026

(54) DISTRIBUTED ADAPTIVE PRUNING IN GOSSIP LEARNING FOR MOBILE EDGE DEVICES

(71) Applicant: Dell Products L.P., Round Rock, TX (US)

(72) Inventors: Paulo Abelha Ferreira, Rio de Janeiro (BR); Julia Drummond Noce, Rio de Janeiro (BR); Isabella Costa Maia, Bertioga (BR)

(21) Appl. No.: 19/012,757

(22) Filed: Jan. 7, 2025

(51) Int. Cl. G06F 17/16

(52) U.S. Cl. CPC G06F 17/16

(57) ABSTRACT

One example method includes joining a learning federation, initializing a respective local model, and setting one or more corresponding internal parameters, receiving, as part of a reception procedure and in response to a transmission procedure performed by peer nodes of the federation, an external model, and associated matrix information, from one of the peer nodes determined to be available, performing a matrix merge process by updating a local matrix with the matrix information, merging the local model and the external model to create a merged model, checking a quality of the merged model, updating the local matrix with quality information concerning the merged model, and, transmitting the merged model and the local matrix to the peer nodes determined to be available.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to training and development of ML (machine learning) models. More particularly, at least some embodiments relate to systems, hardware, software, computer-readable media, and methods, for distributed adaptive pruning in gossip learning for mobile edge devices.

### BACKGROUND

There are situations in which there may be a need for a Machine Learning (ML) model be trained and deployed to a massive number of nodes, one example being self-driving connected vehicles. However, data at the edge nodes might be under strict regulation, such as sensitivity or confidentiality, and there may also be network restrictions for communication between nodes and a central node. Additionally, as each edge node collects its own dataset, the nodes might have differences in the data distribution that should be considered for robust training.

Federated Learning (FL) is one possible approach for attempting to deal with these problems. FL is a distributed framework for machine learning where several nodes jointly train a model without ever sharing their data, that is, the edge data is kept private and not shared among nodes. While FL provides a private framework for this task, it still requires the movement of model updates from edge nodes to a central server, which might be unfeasible due to network constraints in uplinks to the cloud. Gossip learning (GL) is a technique that enables distributed ML without the need for a central node, thus possibly decreasing the network cost, such as in terms of bandwidth usage for example. However, conventional GL approaches are problematic.

For example, many environments lack data heterogeneity and, instead, can be expected to provide some variability in the data, such that there may be a need to adapt training processes accordingly. As another example, many environments present network restrictions in terms of parameters such as communication bandwidth. As a result, training processes that require data movement between nodes are handicapped by such restrictions.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an algorithm for GL.

FIG. 2 discloses aspects of an algorithm for a reception procedure, according to an embodiment.

FIG. 3 discloses a summary of a reception procedure, according to an embodiment.

FIG. 4 discloses an algorithm for merging two pruning matrices, while keeping the data in the matrices updated, according to one embodiment.

FIG. 5 discloses an algorithm for merging two models, given a pruning matrix G, according to one embodiment.

FIG. 6 discloses an algorithm for a transmission procedure, according to one embodiment.

FIG. 7 discloses a summary of a transmission procedure, according to an embodiment.

FIG. 8 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to training and development of ML (machine learning) models. More particularly, at least some embodiments relate to systems, hardware, software, computer-readable media, and methods, for distributed adaptive pruning in gossip learning for mobile edge devices.

One or more embodiments comprise a method for distributed adaptive pruning in gossip learning for mobile edge devices. One or more of the mobile edge devices may be autonomous unmanned vehicles (UAV) in one embodiment. One such method may be performed at one, a subset of, or all, nodes of an edge environment. In an embodiment, performance of the method at one node may occur before, during, and/or after, performance of the method at one or more other nodes.

One embodiment of a method may comprise operations including: joining a learning federation; initializing a respective local model, and setting corresponding internal parameters; calling a transmission procedure; receiving an external model, and associated matrix information, from a node; updating a local matrix with the matrix information; merging the local model and the external model to create a merged model; checking quality of the merged model; updating the local matrix with quality information concerning the merged model; and, transmitting the merged model and the local matrix to one or more other nodes. In an embodiment, the receiving and transmitting operations may be performed in a loop until one or more criteria are satisfied.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a node may make model pruning decisions based on information concerning model instances at other nodes of an edge environment. In an embodiment, a node may learn improvements to a local model based on information obtained by that node from other nodes. An embodiment may reduce, relative to conventional approaches, a risk that a local model of a node will be over, or under, pruned. An embodiment may speed up, relative to conventional approaches, convergence of a model to a specified level of quality or performance. Various other advantages of one or more example embodiments will be apparent from this disclosure.

### A. REFERENCES

Reference is made herein to various documents, listed immediately below. These documents are incorporated herein in their respective entireties by this reference.
[1] Hegedűs, István, Gábor Danner, and Márk Jelasity. “Gossip learning as a decentralized alternative to federated learning.” IFIP International Conference on Distributed Applications and Interoperable Systems. Springer, Cham, 2019.
[2] Zhang, Chen, et al. “A survey on federated learning.” Knowledge-Based Systems 216 (2021): 106775.
[3] Ma, Zhenguo, et al. “Like attracts like: Personalized federated learning in decentralized edge computing.” IEEE Transactions on Mobile Computing 23.2 (2022): 1080-1096.

### B. ASPECTS OF AN EXAMPLE CONTEXT FOR ONE EMBODIMENT

The following is a discussion of aspects of an example context for various embodiments. This discussion is not intended to limit the scope of the claims or this disclosure, or the applicability of the embodiments, in any way.

### B.1 Distributed (Gossip) Learning

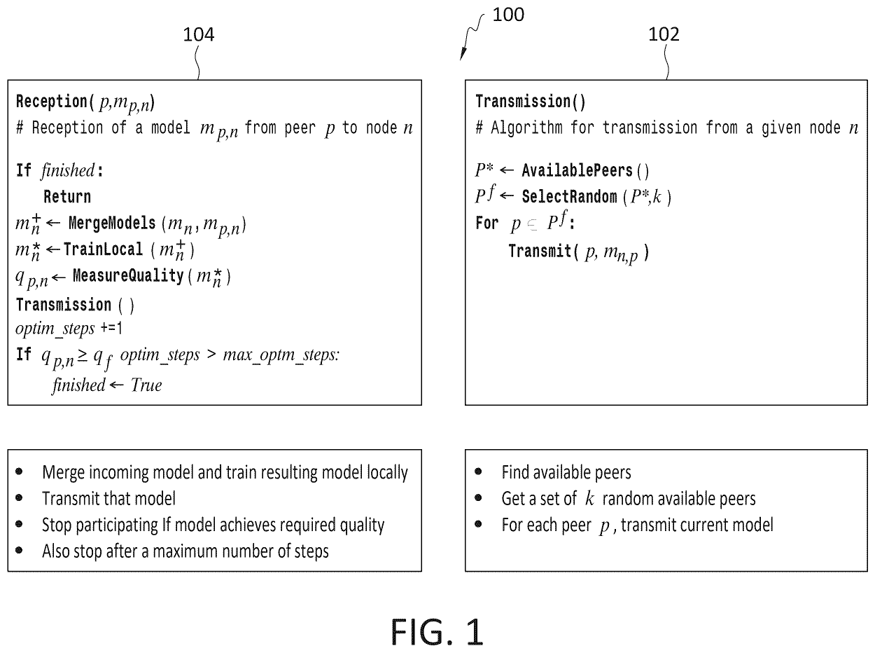

Gossip learning is an asynchronous protocol for learning models from fully distributed data without central control. FIG. 1 discloses some example pseudocode 100 for distributed (Gossip) Learning (GL). As shown, there are two main procedures in the example of FIG. 1: a Transmission procedure 102 and a Reception procedure 104. The Transmission procedure 102 serves to transmit the current model of a node to a random selection of its available peers. The Reception procedure 104 is responsible for merging an incoming model with the node's model and then deciding whether to stop the node training procedure or transmitting the model by calling the Transmission procedure 102.

The decision to stop a node training process and, along with that, transmission of the local model of the node to other peer nodes, may be based on one of two factors: a given quality level being achieved by the merged model; or a given number of optimization steps already performed. One approach may also count the number of steps and decide to stop, so as to avoid a situation where the node continues to merge models, and transmit the merged model even though the merged model might be stuck on a low quality, such as can occur when the node is dealing with a very different data distribution.

In an initialization procedure, all nodes may initialize their models, with random weights for example, and set four internal parameters, namely: (1) k for how many peer nodes to sample from at each transmission; (2) qf for an acceptable final quality threshold; (3) max_optm_steps for a maximum number of optimization steps before leaving the distributed training; (4) finished←False, so the process may start by participating in training. Then, the distributed training starts by all nodes calling their Transmission procedure 102.

### B.2 Personalized FL in Decentralized Edge Computing

The method proposed in [3] focuses on enhancing federated learning (FL) in decentralized edge networks. That approach is a decentralized personalized FL (DPFL) method, which integrates adaptive model pruning and a peer selection mechanism based on gradient similarity. This approach aims to circumvent the typical bottlenecks and single points of failure in centralized systems by employing a peer-to-peer (P2P) setup, which allows for collaborative model training across devices with varying communication capabilities.

Reference [3] reveals that balancing the extent of pruning is important, as excessive pruning increases Q and degrades model performance, while insufficient pruning fails to optimize communication efficiency. A major limitation of the method proposed in [3], and by way of contrast with one or more embodiments, is that in [3], neighbor nodes are chosen according to prune-masked cosine similarity. However, this approach fails to directly consider the resulting validation quality of model merging. That is, there is no distributed knowledge about how each pruning affects each local model. In other words, this local pruning does not consider the different data at each node. It may be that some nodes support higher or lower pruning in relation to other nodes, according to their data. Local pruning has access, if at all, to other node pruning results only very indirectly through its own results of merged models.

By way of contrast with the approach in [3], one or more embodiments comprise a method that customizes or adapts the pruning to each node in the network based on an actively maintained distributed data structure. A method according to one embodiment may better tune a pruning factor that is good for each node, as in relation to its peers, according to an adaptive strategy that learns dynamically as the distributed learning protocol runs on the network.

### C. OVERVIEW OF ASPECTS OF ONE OR MORE EMBODIMENTS

There may be scenarios involving the use of an edge device such as self-driving connected vehicles that collect substantial amounts of heterogeneous data to navigate long distances, where the network can vary along the way. In these scenarios, the autonomous vehicle would have to adapt to different conditions in the route such as new weather or traffic distributions, requiring efficient communication between the edge nodes considering all the experiences of each participant node.

It may be possible for a hybrid FL approach to tackle this problem if such approach did not have any network restrictions in some geographic regions. Network usage may be an important factor in the efficiency of the communication between the edge nodes. However, because of the advantage of working in scenarios with network restriction, an embodiment comprises an improved and efficient method of the GL algorithm that is sensitive to the restrictions imposed by lower communication bandwidth in the network.

In an embodiment, model pruning under distributed learning in prior art is treated independently for each node. That is, each node prunes its own local model according to a global limit of network capacity. Methods according to one or more embodiments also use regularization considering pruning masks coming from the transmitting and receiving node. Thus, an embodiment comprises a combination of both the local and the pruning-aware regularization into a single distributed optimization objective.

In more detail, an embodiment comprises a method that includes customizing, or adapting, the pruning on a per node basis, considering globally shared information. In other words, an embodiment may better tune a pruning factor that is good for each node according to an adaptive strategy that learns dynamically as the GL protocol training runs on the network. A method according to one embodiment requires little communication bandwidth overhead and is tailored for networks on the order of thousands of nodes, or more.

An embodiment may comprise a method that includes customized pruning for each node according to an adaptive strategy that learns dynamically as the GL protocol training runs on the network. Such an embodiment is performance robust because it provides a feedback mechanism for a node to know which pruning has worked best for its peers by simply maintaining a distributed N×N matrix, where N is the number of nodes.

In an embodiment, this globally shared information matrix is relatively cheap, requiring 2N² bytes for a network with N nodes, and 16-bit float precision on the data structure. Even though the data structure used is O(N²), the actual data structure would be orders of magnitude smaller than the transmitted model and, as such, places a relatively low demand on communication bandwidth, as compared with the bandwidth that would be required to transmit the model. For instance, for a medium-sized model such as YOLOv5l (89 MB) would require approximately 6671 nodes for the data structure to equate to the size of an unpruned model.

Since the data structure enables the pruning of the local models, it partially compensates the extra overhead imposed by it. Additionally, since the data structure might be sparse at some moment in time, straightforward compression techniques may be used to greatly reduce the structure being communicated. Finally, since the matrix might be quite sparse at any given point, an embodiment may make use of compression techniques to greatly reduce the transmission size.

### D. DETAILED DISCUSSION

One embodiment comprises a Machine Learning (ML) method for distributed and adaptive model pruning in network environments with limited bandwidth. This constitutes an improvement over conventional approaches, at least insofar as a method according to one embodiment operates in part by customizing or adapting the pruning per node basis considering globally shared information, thus reducing the risk of over or under pruning, which can occur in approaches such as those in [3], and improving convergence due to tailored pruning being tied to model quality. Concretely, an embodiment may better tune a pruning factor that is good for each node according to an adaptive strategy that learns dynamically as the Gossip Learning (GL) protocol training runs on the network. An embodiment may impose little overhead, and may be well suited for use in networks with a vast number of nodes, such as thousands of nodes, or more.

Classic model pruning entails removing some weights, neurons, or other model parameters, according to a single pruning factor, from the model without hindering the model's output quality by a significant margin. Pruning weights or other model parameters may enable a model to operate more efficiently, such as in terms of time and/or resources consumed, but without materially affecting the performance of the model.

This pruning usually results in a Boolean mask that determines which model weights are going to be pruned, that is, removed, or zeroed on the mask. It is also possible to perform model pruning according to more complex strategies where pruning is done in the order of absolute largest to smallest gradients in comparison to a given single threshold. A method according to one embodiment is agnostic to the pruning method and could make use of various methods including, but not limited to, the method in [3]. In an embodiment, a pruning method is parameterizable by a single parameter.

A method according to one embodiment assesses the quality of incoming models and increases, or decreases, model pruning accordingly. This information is used to update a distributed matrix shared by each node that may, at any given point in time, have approximately the same values for all neighboring nodes. Constructing this pruning matrix enables the nodes to be effectively searching for an optimal pruning for each of its peers. Thus, an embodiment provides a feedback mechanism that enables any given node to know which pruning has worked best for its peer nodes. A method according to one embodiment comprises two stages from the classical distributed (Gossip) learning protocol, namely: receiving a model from peers; and transmitting a model to peers.

### D.1 Dynamics

A method according to one embodiment comprises maintaining an N×N distributed matrix G, where N is the number of participant nodes. The matrix entry G[i, j] contains a triple relating to the transmission from i to j. That is, there is G[i, j]→(p, q, t), where: p is the best pruning so far from node i to node j; q, the resulting quality metric (e.g., accuracy) that j obtained with a model pruned with pruning factor p; and t is the timestamp at which the pruning factor was applied.

Additional to the initialization performed in the classic method, discussed above in connection with FIG. 1, in an embodiment, all nodes initialize their G matrix with (0,1,0) for all entries. That is, an embodiment may start with a pruning level of 0, that is, no pruning) and a measured quality of 1, so as to ensure that all the local models are pruned on the first Transmission call, as discussed further below. Additionally, all nodes initialize a random model and train that model for one step on the local data of the node. Any node joining the learning federation will start out by calling the Transmission procedure 102.

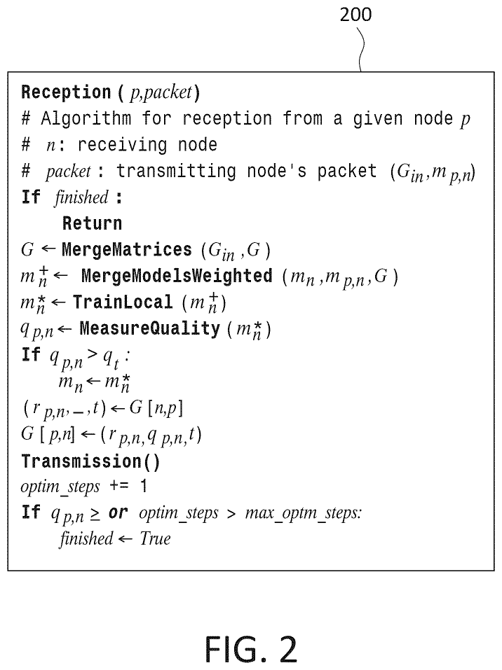

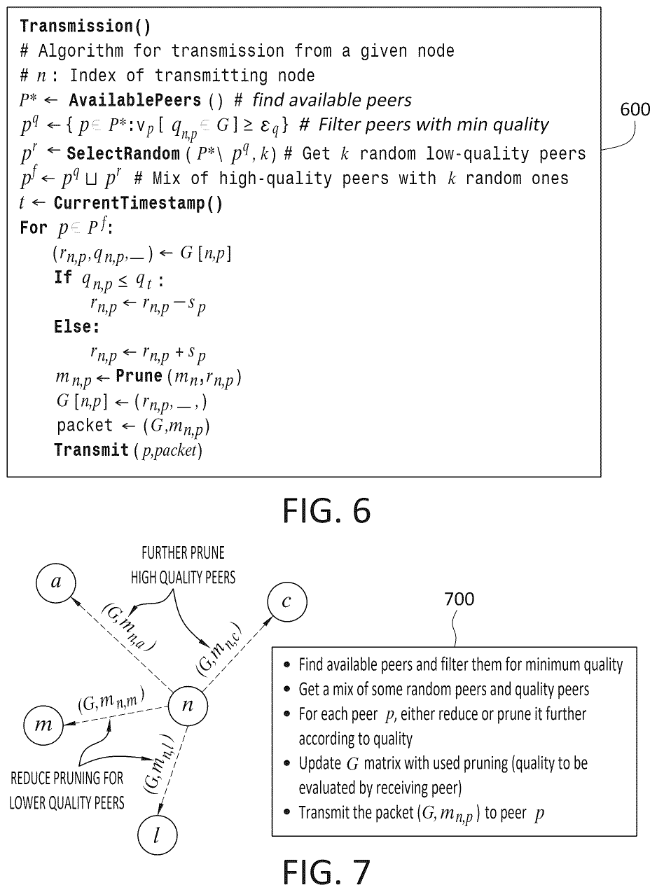

Then, as peers receive the transmitted models and G matrices via the Reception procedure 200 disclosed in FIG. 2. Each peer will update their G matrix and then proceed to merge their local model with the received one, and check for quality of the merged model. Low quality merged models are rejected and not transmitted any further. The G matrix for each peer will then be updated with the obtained quality so that this information is spread around the network when G is transmitted. After finishing with merging and matrix updating, each peer then proceeds to again run the Transmission procedure, an embodiment of which is disclosed in FIG. 6, discussed below. The nodes alternate between the Reception and Transmission procedures. Gradually, each node will construct a G matrix that contains global information on how well the latest pruning is performing across the network for each pair of peers.

In an embodiment, this protocol finishes analogously to how it does in the classic distributed protocol, discussed above in connection with FIG. 1. An embodiment may employ time keeping at nodes so the nodes know that if they do not achieve a given quality threshold after a given amount of time, they too should stop training.

### D.2 Reception

The example Reception procedure, embodied in the algorithm 200 disclosed in FIG. 2 is analogous to, but different from, the classic one discussed earlier herein. In particular, the Reception procedure 200 includes further steps or operations that involve the merging and updating of the pruning matrix G. The quality of the merged model is used to update the matrix G at the corresponding entry. This information can then be used during the Transmission procedure, as discussed elsewhere herein.

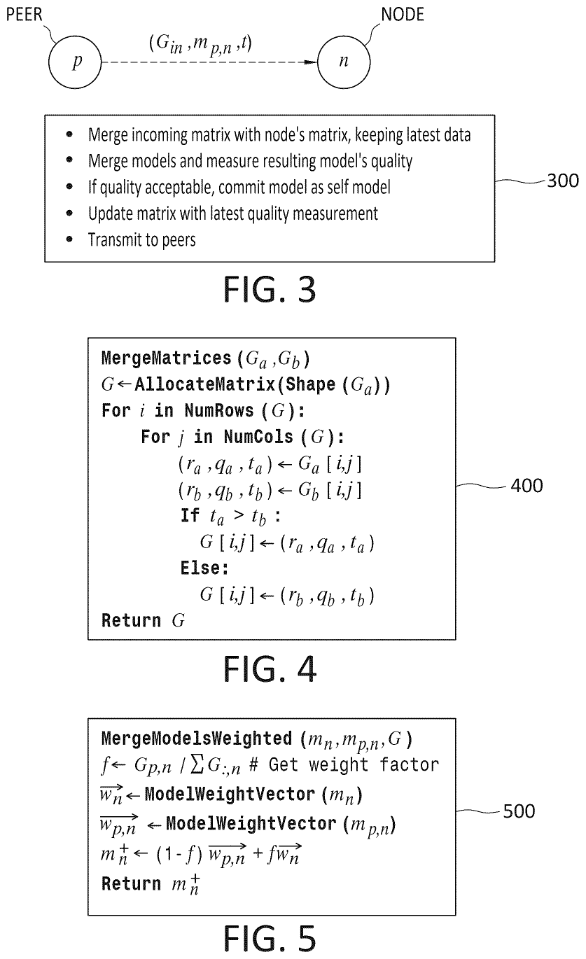

With continued reference to the example of FIG. 2, the first step in the Reception procedure implemented by the Reception algorithm 200, and briefly summarized at 300 in FIG. 3, is to check whether the node has finished its training. The training finished whenever the node has achieved a given model quality or when it has performed a maximum number of optimization steps. Then the Reception algorithm 200 may proceed to merge the incoming matrix with the current matrix node to keep the latest data updated.

In an embodiment, and with continued reference to the example approach 300 of FIG. 3, a Reception algorithm, such as the Reception algorithm 200, may then perform a merge procedure to merge the incoming model with the node local model to test the resulting quality of the merged trained model. First, both models are merged, and then the resulting merged model trained the with the node local data. The Reception algorithm 200 may then measure the quality of this trained and merged model in the local validation data. If the resulting quality is acceptable, an embodiment may keep the trained merged model as the current model in that node. The matrix is updated with the trained and merged model. The node is then ready to transmit the updated matrix, and the trained and merged model, by calling the Transmission procedure.

After calling the Transmission procedure, an embodiment may check the current quality against a final threshold and update our number of optimization steps. This is to keep track if the node is finished with its training so it can opt out of the distributed protocol.

With attention now to FIGS. 4 and 5, algorithms 400 and 500 for performing, respectively, a matrix merge, and a model merge, are disclosed. The algorithm 400, when executed, implements a procedure for merging two pruning matrices, while also keeping the data updated. The algorithm 500, when executed, implements a procedure for merging two models given a pruning matrix G.

More particularly, the algorithms 400 and 500 introduce two procedures, respectively, MergeModelsWeighted for merging pruning matrices, and MergeModelsWeighted, for merging models considering the current pruning matrix. The first procedure, implemented by the algorithm 400, for pruning matrices is straightforward and involves keeping the latest data on the resulting matrix by comparing the timestamps from each entry of each matrix. The second procedure, for merging models, and implemented by the algorithm 500, involves weighing the incoming model by its normalized quality when compared with other models. That is, an embodiment may merge the incoming model in proportion to its quality as compared to other available models in the network that have transmitted to the node that is going to perform the merge.

The other two procedures, namely TrainLocal and MeasureQuality are straightforward and, in one embodiment, could be implemented as follows. The procedure TrainLocal could be implemented as in the classic algorithm for distributed (Gossip) learning. The procedure MeasureQuality could be implemented as measuring the validation error on the local validation dataset and then normalizing this value to a given range of quality values.

### D.3 Transmission

In one embodiment, a Transmission procedure may be analogous to, though not the same as, the classic discussed in connection with the example of FIG. 1. One difference is that the Transmission procedure according to one embodiment includes an extra filtering process to identify quality peers, and another difference is the inclusion of the pruning decision that considers the information in matrix G.

FIG. 6 discloses an example algorithm 600 which, when executed, implements a Transmission procedure according to one embodiment, and FIG. 7 discloses a summary 700 of an embodiment of such a Transmission procedure. As shown, the first step in the Transmission procedure, AvailablePeers, is to decide on the set of peers that are going to be selected for transmission of a model from a node. One embodiment may begin, for example, by checking the available peers in the network and then filtering these by a given quality threshold. Then, an embodiment may add some random peers to introduce some variability in the set of peers. Thus, one embodiment may end up with a mix of high-quality and random peers.

In one embodiment, procedures such as AvailablePeers or Transmit could be implemented in the same manner as in the classic algorithm. An embodiment may comprise various non-standard, or non-classical, procedures: SelectRandom, CurrentTimestamp and Prune. In an embodiment, the SelectRandom procedure may be a simple selection of random elements from a given set of elements. In one embodiment, there is a parameter for choosing k random elements. In an embodiment, the CurrentTimestamp procedure is straightforward and simply operates to obtain a current timestamp form the system running on a given node.

In one example embodiment, the Prune procedure is implemented as a simple weight cut-off, or alternatively, in a more refined manner as in [3]. If the pruning procedure is one such as in [3], a method according to one embodiment may also operate to transmit the model mask from each node. In that way, such an embodiment may keep a similar pruning implementation as presented in [3], where weight masks are taken into consideration, as discussed above. In any case, and without loss of generality, one or more embodiments may employ pruning approaches that take into account a single real value to guide it. Further, an extension to a more complex requirement could be obtained by simply transmitting that factor along in the pruning matrix.

We then proceed to go through the peers and decide to decrease or increase the pruning factor according to measured quality. But first, we get a current timestamp so that when we update the pruning matrix, we allow its future merges to consider latest data. For each peer, we consult the pruning matrix G for the current quality level of the model. If that quality is below a certain threshold, we decrease the pruning; and do the opposite otherwise. Once we decide on the pruning factor, we prune the model, update the matrix with the pruning factor and transmit.

### D.4 Further Discussion

As disclosed herein, one or more embodiments may possess various useful features and advantages, although no embodiment is required to possess any of such features or advantages. The following examples are illustrative, but not exhaustive.

An embodiment may comprise a method that addresses the local pruning challenge by customizing or adapting the pruning to each node in the network based on an actively maintained distributed data structure, such as a matrix. Thus, a method according to one embodiment may better, relative to conventional approaches such as the exampled disclosed herein, tune a pruning factor that is good for each node, as in relation to its peers, according to an adaptive strategy that learns dynamically as the distributed learning protocol runs on the network.

As such, an embodiment may comprise a technological advancement relative to conventional approaches by customizing or adapting the pruning on a per node basis, while also considering globally shared information, thus reducing the risk of over or under pruning, such as may occur in the approaches disclosed in [3], and improving convergence of the model due to tailored pruning being tied to model quality.

In more detail, an embodiment may better tune a pruning factor that is good for each node according to an adaptive strategy that learns dynamically as the Gossip Learning (GL) protocol training runs on the network. An embodiment requires little overhead and may be tailored for networks with a vast number of nodes. Thus, an embodiment may enable adaptive pruning in distributed learning scenarios to better tackle the trade-off between network communication bandwidth usage, and model quality.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. FURTHER EXAMPLE EMBODIMENTS

Following are some further example embodiments. These are presented only by way of example and are not intended to limit the scope of this disclosure or the claims in any way.

### Embodiment 1

A method, comprising: joining a learning federation; initializing a respective local model, and setting one or more corresponding internal parameters; receiving, as part of a reception procedure and in response to a transmission procedure performed by peer nodes of the federation, an external model, and associated matrix information, from one of the peer nodes determined to be available; performing a matrix merge process by updating a local matrix with the matrix information; merging the local model and the external model to create a merged model; checking a quality of the merged model; updating the local matrix with quality information concerning the merged model; and, transmitting the merged model and the local matrix to the peer nodes determined to be available.

### Embodiment 2

The method as recited in claim 1, wherein each of the peer nodes comprises a respective autonomous edge device.

### Embodiment 3

The method as recited in claim 1, wherein the matrix is an N×N matrix, and N is a number of available nodes, of the peer nodes, participating in the transmission procedure.

### Embodiment 4

The method as recited in claim 1, wherein the matrix includes, for each of the peer nodes that is available, a triple [p, q, t] relating to transmission, by that node, of a respective local model to each of the peer nodes, where p is a best pruning so far applied by that node to the local model, q is a quality metric of the local model, and t is a timestamp indicating when a pruning factor was applied by that node to the local model.

### Embodiment 5

The method as recited in claim 1, wherein prior to the merging with the local model, the external model is checked for quality, and the external model is then pruned based on the quality of the external model.

### Embodiment 6

The method as recited in claim 1, wherein the transmission procedure and the reception procedure are both repeated until one or more criteria are met.

### Embodiment 7

The method as recited in claim 1, wherein communication among the peer nodes is performed according to a GL (gossip learning) protocol.

### Embodiment 8

The method as recited in claim 1, wherein the merged model is trained with local node data before being transmitted to the available nodes.

### Embodiment 9

The method as recited in claim 1, wherein after receipt of the external model, the matrix information is used as a basis for pruning the external model.

### Embodiment 10

The method as recited in claim 1, wherein the local model and the external model are both ML (machine learning) models.

### Embodiment 11

A system, comprising hardware and/or software, operable to perform any of the operations, methods, or processes, or any portion of any of these, disclosed herein.

### Embodiment 12

A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

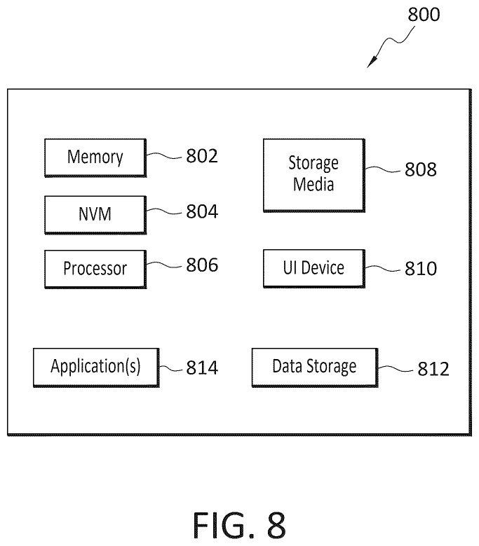

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the algorithms, steps, processes, methods, operations, or portions of any of these, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
joining a learning federation;
initializing a respective local model, and setting one or more corresponding internal parameters;
receiving, as part of a reception procedure and in response to a transmission procedure performed by peer nodes of the federation, an external model, and associated matrix information, from one of the peer nodes determined to be available;
performing a matrix merge process by updating a local matrix with the matrix information;
merging the local model and the external model to create a merged model;
checking a quality of the merged model;
updating the local matrix with quality information concerning the merged model; and
transmitting the merged model and the local matrix to the peer nodes determined to be available.

2. The method as recited in claim 1, wherein each of the peer nodes comprises a respective autonomous edge device.

3. The method as recited in claim 1, wherein the matrix is an N×N matrix, and N is a number of available nodes, of the peer nodes, participating in the transmission procedure.

4. The method as recited in claim 1, wherein the matrix includes, for each of the peer nodes that is available, a triple [p, q, t] relating to transmission, by that node, of a respective local model to each of the peer nodes, where p is a best pruning so far applied by that node to the local model, q is a quality metric of the local model, and t is a timestamp indicating when a pruning factor was applied by that node to the local model.

5. The method as recited in claim 1, wherein prior to the merging with the local model, the external model is checked for quality, and the external model is then pruned based on the quality of the external model.

6. The method as recited in claim 1, wherein the transmission procedure and the reception procedure are both repeated until one or more criteria are met.

7. The method as recited in claim 1, wherein communication among the peer nodes is performed according to a GL (gossip learning) protocol.

8. The method as recited in claim 1, wherein the merged model is trained with local node data before being transmitted to the available nodes.

9. The method as recited in claim 1, wherein after receipt of the external model, the matrix information is used as a basis for pruning the external model.

10. The method as recited in claim 1, wherein the local model and the external model are both ML (machine learning) models.

11. A non-transitory storage medium having stored therein instructions that are executable by one or more hardware processors to perform operations comprising:
joining a learning federation;
initializing a respective local model, and setting one or more corresponding internal parameters;
receiving, as part of a reception procedure and in response to a transmission procedure performed by peer nodes of the federation, an external model, and associated matrix information, from one of the peer nodes determined to be available;
performing a matrix merge process by updating a local matrix with the matrix information;
merging the local model and the external model to create a merged model;
checking a quality of the merged model;
updating the local matrix with quality information concerning the merged model; and
transmitting the merged model and the local matrix to the peer nodes determined to be available.

12. The non-transitory storage medium as recited in claim 11, wherein each of the peer nodes comprises a respective autonomous edge device.

13. The non-transitory storage medium as recited in claim 11, wherein the matrix is an N×N matrix, and N is a number of available nodes, of the peer nodes, participating in the transmission procedure.

14. The non-transitory storage medium as recited in claim 11, wherein the matrix includes, for each of the peer nodes that is available, a triple [p, q, t] relating to transmission, by that node, of a respective local model to each of the peer nodes, where p is a best pruning so far applied by that node to the local model, q is a quality metric of the local model, and t is a timestamp indicating when a pruning factor was applied by that node to the local model.

15. The non-transitory storage medium as recited in claim 11, wherein prior to the merging with the local model, the external model is checked for quality, and the external model is then pruned based on the quality of the external model.

16. The non-transitory storage medium as recited in claim 11, wherein the transmission procedure and the reception procedure are both repeated until one or more criteria are met.

17. The non-transitory storage medium as recited in claim 11, wherein communication among the peer nodes is performed according to a GL (gossip learning) protocol.

18. The non-transitory storage medium as recited in claim 11, wherein the merged model is trained with local node data before being transmitted to the available nodes.

19. The non-transitory storage medium as recited in claim 11, wherein after receipt of the external model, the matrix information is used as a basis for pruning the external model.

20. The non-transitory storage medium as recited in claim 11, wherein the local model and the external model are both ML (machine learning) models.
